(19) United States
(12) Patent Application Publication
(10) Pub. No.: US 2003/0070670 A1
(43) Pub. Date: Apr. 17, 2003

(54) Method of forming stone inlays in wood and article of manufacture

(76) Inventor: Sean Cleary, Redwood City, CA (US)

Correspondence Address: John P. Sutton, 2421 Pierce Street, San Francisco, CA, 94115-1131, US

(21) Appl. No.: 09/975,207

(22) Filed: Oct. 12, 2001

(51) Int. Cl. B28D 1/00

(52) U.S. Cl. 125/1; 125/30.01

(57) ABSTRACT

A method of forming a stone inlay in an abrasion-sensitive substrate, such as wood, by forming a depression in the substrate, mounting stone on a damping material capable of absorbing the abrasive energy applied to the stone in reducing the dimensions of the stone to fit the depression, cutting the inlay to size and inserting it into the substrate. The cut inlay/damping material composite may be sold separately as an article of manufacture.

### FIELD OF THE INVENTION

Inlays of marble, granite and other stones and vitreous materials have been used in decorative arts for centuries. Normally, the inlay and the substrate are of like materials so that the surface may be polished to a degree necessary to make clear images of different colors, textures and impressions desired in the final product. For example, if the medium is wood, the substrate is generally wood and the inlays are of variously colored wood fragments. Likewise, if the inlays are stone, the substrate is usually a similar hard, brittle material that may be polished with abrasives that could not be used on wood because they would damage the wood rather than polish it.

Inlays of materials dissimilar to the substrates, as far as hardness is concerned, have been difficult to prepare because of the different polishing requirements. Stone in wood, for example, has heretofore required the inlay to be formed in precisely the dimensions of the final product, then polished to the degree desired in the final product. Where the dimension of the inlay is small, say, less than two centimeters in the shortest dimension, there is a substantial risk that the brittle stone will break or chip, making the inlay useless and requiring a new beginning. In the Middle Ages, when the cost of skilled workers and stone materials was no object, trial and error over and over was a possibility. Today, however, there is a need for a reliable method of making inlays of hard materials for insertion into substrates of soft materials.

Moreover, different trades are involved in stone work and in cabinetry. In kitchen remodeling, for example, a cabinet-maker will prepare drawers, doors and storage units for a kitchen, and a different tradesman will cut and install granite or marble counter surfaces. Making stone inlays in wood cabinets, made possible by the present invention, involves a marriage of two dissimilar trades, accounting for the fact that inlays of stone in wood are seldom attempted today.

There is a need for a new article of manufacture, consisting of a composite of stone or a somewhat flexible damping material that can be purchased by a cabinet-maker and simply inserted with an adhesive into a groove in wood formed by a suitable means, such as a router.

### SUMMARY OF THE INVENTION

The present invention is a method of making inlays of hard material in small cross-sectional dimensions for insertion into softer material that would be damaged by the strenuous abrading materials used in polishing hard materials. A damping material is used to mount the hard material for processing steps of grinding and polishing in order to avoid chipping and breaking of the hard brittle material, especially in the dimensions on the order of two centimeters or less.

In particular, granite and marble inlays in wood provide a beautiful contrast in texture and colors that are desirable in the decorative arts. Furniture, storage cabinets, and virtually any wooden surface used in construction may be decorated with stone inlays at modest cost using the present invention.

In addition, the invention includes an article of manufacture consisting of a composite of stone and damping material having a precise configuration for insertion into a wood or other relatively soft substrate.

### BRIEF DESCRIPTION OF THE DRAWINGS

FIG. 1 is an isometric view of a raw stone resting on a mount before processing.

FIG. 2 is an isometric view of a composite of stone and damping material in a mount.

FIG. 3 is an isometric view of an inlay composite ready to be inserted into the substrate.

FIG. 4 is an isometric view of a curvilinear inlay mounted on damping material and cut to the desired dimensions.

FIG. 5 is a plan view of the completed inlay with multiple curvilinear elements as in FIG. 4.

### DESCRIPTION OF THE PREFERRED EMBODIMENTS

The method of the present invention may be used with any of a variety of hard, brittle materials, such as concretions of stone, like marble or granite, or vitreous materials that are hard and brittle, yet capable of being cut and polished in the form of inlays. Concretions made of Portland or magnesium oxychloride cement or the like are also contemplated as the hard materials. Here, I shall use the term “stone” to refer to all such hard, brittle materials, even though vitreous materials are not, strictly speaking, concretions.

The substrate may be any material that is substantially softer than stone, such that it would be damaged by the harsh abrasions used with hard materials to form highly polished surfaces desired in inlays. Thus, synthetic plastic materials, whether thermoplastic or thermosetting, may be used as substrates. By far the preferred substrate is wood, which can provide a huge variety of graining, color, and texture. The combination of stone and wood is aesthetically pleasing as decoration for any kind of construction, from buildings, interior and exterior, and interior decoration.

The mount on which the stone is mounted for processing as a composite may be any material that absorbs the grinding and polishing energy imparted to the hard material so that the brittle stone will not break or chip. Thermosetting resins are suitable materials, because they may be ground along with the hard material using conventional techniques. It is important, of course, that the mount not be elastomeric to the extent that it gums up grinding wheels or other abrading devices. One skilled in the art can select a suitable mount from the array of available commercial products.

One example of a mount is a filled resin sold under the trade name Surrell, by Formica Corp., Cincinnati, Ohio. It is believed to be about 40% polyester/acrylate resin filled with about 60% aluminum trihydrate. It is available in sheets that can be readily cut and routed to form a depression approximating the depression formed in the substrate into which the final stone inlay is to be processed. When stone is mounted in Surrell, the abrading of the sides of the inlay to reach the desired width of inlay easily abrades the Surrell as well as the stone.

A preferred mounting material is plywood having a sufficient number of layers to provide damping when used to support stone for polishing. I use half-inch plywood and use the same router that makes the depression in the substrate, so that the dimensions of the trough in the mount is exactly the same as those of the substrate. Also, plywood is dimensionally stable, even when wet. Any exterior grade plywood is suitable, preferably at least ⅜ inch thick.

Whatever damping material is used for mounting the stone for polishing, the stone is inserted into the trough filled with sufficient damping material to absorb the energy applied to the stone by abrasion. A composite of stone and damping material is formed in the trough of the mount. The composite and mount are then abraded to make a smooth surface on the exposed face of the inlay. The final polishing of stone is with a diamond pad of extremely fine particles, such as 3500 grit. I have found that a plywood mount “gives” or compresses more than a Surrell mount so that the extremely fine final polish does not abrade plywood, though it can abrade Surrell. Surrell is a good mount for heavy abrading; plywood is a good mount for extremely fine polishing. Plywood occasionally has gaps or voids between plies, which can drain off adhesive, leaving a gap between stone and mount. Surrell has no gaps or voids.

Because it is desired to secure the inlay to the damping material so that the stone will not fall out when the finished composite of inlay and damping material is inverted, I prefer to use an adhesive to serve as both the securing means and as a damping means. The preferred adhesive/damping material is epoxy resin, a widely available adhesive. Epoxy is dimensionally stable, unlike many adhesives that shrink. The epoxy resin flows before it is cured, so I prefer to make a trough in a mount of either Surrell or plywood that is exactly the shape of the finished inlay. My preferred epoxy resin is one that has a viscosity like honey. It is AKEPOX 2000, sold by Akemi company in Nuraburs, Germany. I then pour epoxy resin into the trough in a sufficient amount to adhesively secure the stone without any voids or bubbles. The stone to be finished is inserted into the trough of the mount before the epoxy resin cures and then the resin is cured, forming a composite of stone/epoxy/mount. The composite is then abraded on the exposed surface and on the sides to any shape desired and the bottom of the three-part composite is abraded to allow the finished product to lie flush in the depression formed in the substrate. Because the abrading of the bottom of the composite follows the grinding and polishing of the exposed surface of the stone, it is possible that all of the Surrell or plywood is removed, leaving only stone and epoxy as the composite to be inserted into the substrate.

The greater the depth of supporting epoxy, the more flexible the stone/epoxy composite is, that is, the thickness of the stone in relation to the thickness of the damping material should be in a ratio of at least 1:2 to minimize the risk of breaking or chipping the stone.

The final processing step in forming an article of manufacture is to bevel the sides. The final product may be sold in commerce to others who will rout a substrate and insert the article of manufacture into the depression in the substrate. I prefer to make a slope on each side of the composite inlay of stone and damping material. The slope should be one to ten degrees inward from vertical, with the optimum of 5°. That is, the top of the composite is wider than the bottom of the composite. This permits a sufficient amount of adhesive, such as epoxy, used to secure the composite article of manufacture to the trough in the substrate to prevent a gap from forming with the passage of time. Wood tends to shrink or warp, leaving an unsightly gap between substrate and inlay if the adhesive does not fully bond the inlay to the substrate along the entire length of the inlay.

When the trough is rectangular in cross-section and the stone has a similar cross-section and epoxy resin is flowed over the sides and bottom of the stone to secure it to the mount, the final product may have no plywood or Surrell left in the composite. The abrading of the sides and the bottom of the composite may well leave only epoxy and stone. This is satisfactory, however, because the epoxy is effective as a damping material. Accordingly, epoxy resin may be used as the sole damping material, if desired. To prevent the epoxy from flowing away from the stone before it is cured, the mount can hold the epoxy/stone composite until it is cured. For example, I have used plywood with a trough in the shape of the inlay as the mount, since the entire mount is removed in forming the final inlay/epoxy composite as an article of manufacture.

The stone for the inlay is cut from a larger piece of stock to dimensions larger than the dimensions of the inlay in the final product. I have found that the shortest dimension should not be less that a centimeter or two, depending on the type of stone, or else the material will crack, break or chip when being separated from the larger stock. When the stone is mounted to form a stone/damping material composite, then smaller dimensions of stone may be accommodated.

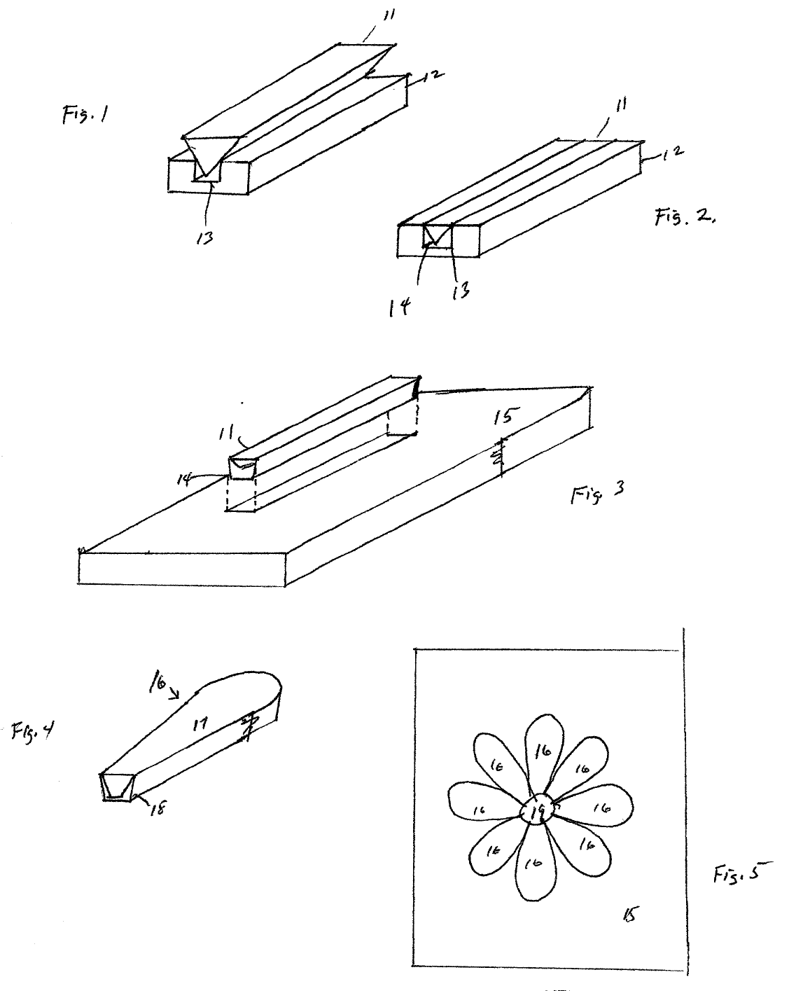

FIG. 1 shows the raw stone 11 mounted on mount 12. Mount 12 has a trough 13 cut into it to hold stone 11. Stone 11 has a generally V-shaped bottom to rest in a substantial amount of damping material flowed into through 13. Stone 11 is placed on mount 12 so that when cut to be flush with the surface of the mount the widest dimension of the stock as mounted is the hypotenuse of a triangle flush with the surface of the mount material as shown in FIG. 2. In that way, the hypotenuse is longer than the width of the final inlay, allowing for a reduction in size to the final dimension.

The reason for mounting the raw stone with the hypotenuse of the triangle formed diagonally across the cross-section (as shown in FIG. 2) is to minimize the amount of stone to be cut on each side, and to maximize the amount of damping material supporting the stone that is being abraded. The more the damping material that supports the stone, the safer is the grinding operation to reach the final dimensions of the stone inlay. Also, a substantial backing of damping material allows a relatively thin stone to be processed without breaking.

FIG. 2 shows the composite of stone 11 in damping material 14 that is placed in trough 13. The damping material is softer than the stone, so stone-abrading techniques are not needed to remove the excess. The generally V-shape cross section of the bottom of the stone permits maximum damping in the final grinding to the desired width. The damping material 14 may concurrently be epoxy resin in an amount greater than the amount of stone 11 in the composite.

Stone 11 is ground and polished to the desired dimensions in the Y-axis in FIG. 2. The slight reduction in the horizontal X-axis is safely accomplished by reason of the large amount of damping material supporting the edges. The substantial reduction in the Y-axis is safely accomplished because of the substantial amount of damping material 12 supporting the entire stone. More than half of the stone 11 in FIG. 1 is abraded away to form a flat, polished surface as shown in FIG. 2. The mount is then cut away to leave a slightly leveled composite of stone 11 and damping material 14 ready to be inserted into substrate 15 as shown in FIG. 3. A slight slope downwardly and inwardly in the composite of stone 11 in damping material 14 serves to allow a tight adhesive seal between the composite 11 and 14 and substrate 15. The slope should be 1° to 10° from vertical, with the optimum being 5° from vertical. When the proper width is reached for the stone inlay, the bottom of the composite may be shaved to reach the precise depth of the depression formed in the substrate 15, as by a router or other device for making a straight-sided depression for receiving the inlay.

FIG. 3 shows the final composite ready to be inserted into substrate 15. The substrate 15 is highly polished with suitable abrasives for wood and finished as desired. The inlay 11 is flush with the surface of substrate 15 and has a high polish as well. The two polished surfaces could not have been formed in situ, because of the differential in hardness. The embedded inlay 11 has a generally V-shaped cross-section as shown in FIGS. 2 and 3. It is secured to the substrate 13 by any suitable means, such as epoxy resin.

Any shape of inlay may be formed using the present invention. For example, a curvilinear inlay in the shape of a flower petal is shown in FIG. 4. Petal 16 consists of a stone surface 17 mounted on a damping material 18. The damping material is thicker at the edges to provide maximum support during the abrading of the edges to reach the precise fit for the depression formed in the substrate (not shown). The composite of stone 17 and damping material 18 of FIG. 4 has been polished on the exposed surface and cut to the precise size needed to fit into the substrate. Again, a slight slope is provided on the sides of the composite.

The slope along the edges of stone 17 allows a greater amount of supporting damping material 17 to prevent breaking or chipping of the edges during abrasion to reduce the size of the piece 16 to the desired dimensions. A lesser amount of damping material is placed under the bottom of stone 17. Again, if the smallest dimension of stone 17 is under 2 centimeters, the amount of supporting damping material 18 should be greater to allow flexibility of the composite of stone 17 and damping material 18. The damping material at the bottom of the composite may easily be sanded down if necessary to make the piece 16 flush with the surface of the substrate when finished. The sloped sides of stone 17 in FIG. 4 are required only if the cross-sectional width of piece 14 is about two centimeters or less. If piece 14 is larger, then straight sides may be used.

FIG. 5 is a top view of the finished product containing a flower made of multiple curvilinear elements 16 like those of FIG. 4 arrayed around a center stone piece 19. Obviously, any degree of complexity in design may be accommodated. However, each piece narrower than about two centimeters should be shaped with a sloping side to give maximum support of damping material under a minimum depth of stone during the step of reducing the dimensions of the stone to fit in the depression formed in the substrate 15. Also, the sides of composites of stone and damping material should also be slightly sloped to insure that gaps do not form between stone 17 and substrate 15.

It will be apparent to one skilled in the art that any hard, brittle material may be shaped and polished into a precisely dimensioned inlay apart from the substrate into which it is to be inserted, so that polishing of the hard material will not damage the substrate as it would if performed in situ.

1. In a method for inlaying a polishable stone cut to be inserted into a depression formed in a softer substrate that would be damaged by the polishing step for the stone if contacted by a polishing device, the improvement comprising (1) mounting stone having dimensions larger than the depression formed in the substrate for receiving the stone inlay on damping material capable of absorbing the energy of abrading the stone to the precise dimensions of the receiving substrate, (2) reducing the dimensions of edges of the inlay mounted on the damping material to precisely match the dimensions in the depression formed in the substrate, (3) polishing the surface to be exposed on the inlay before inserting it into the substrate, (4) reducing the depth of the inlay/damping material composite to precisely match the depth of the depression formed in the substrate, and (5) securing the inlay to the substrate by conventional means.

2. A method as in claim 1 wherein the polishable stone is granite.

3. A method as in claim 1 wherein the polishable stone is marble.

4. A method as in claim 1 wherein the polishable stone is vitreous.

5. A method as in claim 1 wherein the depth of the inlay at the longitudinal centerline of the inlay is greater than the depth at the edges, whereby the thickness of the damping material on which the inlay is mounted is greater at the centerline than at the edges.

6. A method as in claim 1 wherein the damping material is melamine-formaldehyde resin.

7. A method as in claim 1 wherein the damping material is epoxy resin.

8. A method as in claim 1 wherein the dimensions of the inlay are reduced by grinding.

9. A method as in claim 1 wherein the polishing of the inlay is by a polishing stone.

10. A method as in claim 1 wherein the securing of the inlay in the depression formed in the substrate is by epoxy resin.

11. A method as in claim 1 wherein the cross-sectional view of the stone inlay is generally V-shaped with thinner edges and a thicker center, to minimize the amount of inlay to be reduced at the edges, relative to the amount of the damping material.

12. A method as in claim 1 wherein the bottom of the inlay mounted on the damping material is composed of epoxy resin.

13. A method as in claim 11 wherein the depth of the inlay/damping material is matched to the depth of the depression formed in the substrate by sanding.

14. A method of inlaying stone in wood comprising:
a) forming a depression in a wood substrate by a suitable device to the dimensions desired for the inlay;
b) mounting stone having dimensions larger than those of the depression formed in the wood on damping material to form a stone/damping material composite having a width and a depth greater than the depression in the substrate;
c) abrading the sides of the inlay/damping material composite to precisely match the sides of the depression formed in the wood;
d) polishing the surface to be exposed on the inlay in the final product to the desired degree;
e) abrading the damping material on the bottom of the inlay/damping material composite to precisely match the depth of the depression formed in the wood;
f) applying an adhesive to at least one of the depression formed in the wood and the surfaces of the stone/damping material composite to secure the composite in the wood; and
g) inserting the inlay/damping material composite into the depression before the adhesive in step (f) cures.

15. A method as in claim 14 wherein the damping material is a thermosetting resin.

16. A method as in claim 14 wherein the damping material is a filled synthetic resin.

17. A method as in claim 14 wherein the damping material is epoxy resin.

18. A method as in claim 14 wherein the cross-sectional dimension of the stone inlay is thinner at the edges and thicker at the center, whereby the abrading step (c) has relatively more damping material and relatively less stone to abrade in order to reach the final dimensions desired.

19. A method as in claim 14 wherein the shortest surface dimension of the inlay is less than two centimeters.

20. A method as in claim 19 wherein the shortest surface dimension of the inlay is less than one centimeter.

21. An article of manufacture comprising a stone inlay having a flat, polished top surface and a cross-section having less stone at the longitudinal edges of stone inlay than at the centerline, bonded to a damping material supporting the entire bottom surface of the inlay, said damping material having sides sloping downwardly and inwardly toward a bottom surface of the damping material.

22. An article as in claim 21 wherein the sloped sides of the damping material are between 1 degree and 10 degrees from vertical.
